(19) United States
(12) Patent Application Publication
(10) Pub. No.: US 2024/0429390 A1
(43) Pub. Date: Dec. 26, 2024

(54) Positive Electrode Active Material, All-Solid-State Battery, and Method of Producing Positive Electrode Active Material

(71) Applicant: TOYOTA JIDOSHA KABUSHIKI KAISHA, Toyota-shi Aichi-ken (JP)

(72) Inventor: Masaru KUBOTA, Okazaki-shi Aichi-ken (JP)

(73) Assignee: TOYOTA JIDOSHA KABUSHIKI KAISHA, Toyota-shi Aichi-ken (JP)

(21) Appl. No.: 18/748,607

(22) Filed: Jun. 20, 2024

(30) Foreign Application Priority Data
Jun. 22, 2023 (JP) 2023-102311

(51) Int. Cl. H01M 4/62; H01M 4/02; H01M 4/04; H01M 10/0562

(52) U.S. Cl. CPC H01M 4/62; H01M 4/0416; H01M 10/0562; H01M 2004/028

(57) ABSTRACT

A positive electrode active material includes an active material particle and a coating film. The coating film covers at least a part of a surface of the active material particle. The coating film includes oxygen and a glass forming element. The glass forming element includes phosphorus and silicon. The positive electrode active material satisfies relationships of a formula (1) of “C_{Li}/C_{X}≤2.50” and a formula (2) of “0<C_{Si}/C_{X}”. C_{Li}, C_{X} and C_{Si} respectively represent element concentrations measured by X-ray photoelectron spectroscopy. C_{Li} represents an element concentration of lithium. C_{X} represents a total element concentration of the glass forming element. C_{Si} represents an element concentration of silicon.

### CROSS REFERENCE TO RELATED APPLICATIONS

This nonprovisional application is based on Japanese Patent Application No. 2023-102311 filed on Jun. 22, 2023 with the Japan Patent Office, the entire contents of which are hereby incorporated by reference.

### BACKGROUND

### Field

The present disclosure relates to a positive electrode active material, an all-solid-state battery, and a method of producing a positive electrode active material.

### Description of the Background Art

Japanese Patent Application Laid-Open No. 2012-099323 discloses a coating layer having a polyanion structure portion.

### SUMMARY

A sulfide-based all-solid-state battery (hereinafter, also simply referred to as “all-solid-state battery”) has been developed. The all-solid-state battery includes a sulfide solid electrolyte. In a positive electrode, an active material particle has a high potential. When the sulfide solid electrolyte is brought into direct contact with the active material particle in the positive electrode, the sulfide solid electrolyte may be deteriorated. The deterioration of the sulfide solid electrolyte (ion conduction path) may lead to increased battery resistance. To address this, it has been proposed to form a coating film on a surface of the active material particle. The coating film blocks direct contact between the active material particle and the sulfide solid electrolyte, thereby reducing deterioration of the sulfide solid electrolyte. However, the coating film is also a resistive component. Even though the deterioration of the sulfide solid electrolyte can be reduced, a desired battery resistance may not be obtained due to a high resistance of the coating film.

It is an object of the present disclosure to reduce a battery resistance.
1. A positive electrode active material includes an active material particle and a coating film. The coating film covers at least a part of a surface of the active material particle. The coating film includes oxygen and a glass forming element. The glass forming element includes phosphorus and silicon.

The positive electrode active material satisfies relationships of the following formulas (1) and (2):

$${C}_{Li} / {C}_{X} \leq 2.5 ; and \qquad ( 1 )$$

$$0 < {C}_{Si} / {C}_{X} . \qquad ( 2 )$$

In the formulas (1) and (2), C_{Li}, C_{X} and C_{Si} respectively represent element concentrations measured by X-ray photoelectron spectroscopy. C_{Li} represents an element concentration of lithium. C_{X} represents a total element concentration of the glass forming element. C_{Si} represents an element concentration of silicon.

Japanese Patent Application Laid-Open No. 2012-099323 proposes a coating layer including a polyanion structure portion. The coating layer in Japanese Patent Application Laid-Open No. 2012-099323 corresponds to the coating film in the present disclosure. The polyanion structure portion includes Li₃PO₄—Li₄SiO₄. In the example of Japanese Patent Application Laid-Open No. 2012-099323, the molar ratio in the coating film is “Li/P/Si=7/1/1”. It is considered that Li included in the coating film is an ion conductive carrier. According to the conventional findings, as the Li composition ratio is larger, the battery resistance is expected to be reduced more.

However, according to the new findings of the present disclosure, the battery resistance can be significantly reduced by reducing the Li composition ratio to a specific value or less. The left side of the formula (1) represents the Li composition ratio. The element concentrations such as Cui are measured by X-ray photoelectron spectroscopy (XPS). The XPS acquires information of the outermost surface of a measurement target (positive electrode active material). That is, it is considered that the Li composition ratio measured by the XPS represents the Li composition ratio in the coating film. When the Li composition ratio is 2.5 or less as shown in the above formula (1), a reduction in battery resistance is expected. It should be noted that the Li composition ratio in Japanese Patent Application Laid-Open No. 2012-099323 is considered to be about 3.5.

Phosphorus (P) is a glass forming element. That is, P can form an oxide glass (glass network) together with oxygen (O). Silicon (Si) is also a glass forming element. The coexistence of the two or more glass forming elements may lead to formation of a composite glass network. The glass network is considered to include two or more types of anions (PO₄³⁻, SiO₄⁴⁻, etc.). The coexistence of the two or more types of anions is expected to cause exhibition of a mixed anion effect. The mixed anion effect is expected to promote ion conduction. That is, a reduction in battery resistance is expected.
2. The positive electrode active material described in “1” above may include, for example, the following configuration.

The glass forming element further includes boron.

The positive electrode active material further satisfies a relationship of the following formula (3):

$${C}_{Si} / {C}_{X} < 0.1 \qquad ( 3 )$$

Boron (B) is also a glass forming element. The combination of P and B is expected to promote the mixed anion effect. An amount of Si may be smaller than those of P and B. For example, P and B form a skeleton of the glass network and Si may be partially introduced. By introducing a small amount of Si into the glass network, it is expected to promote the ion conduction.
3. An all-solid-state battery includes a positive electrode and a negative electrode. The positive electrode includes the positive electrode active material described in “1” or “2” above and a sulfide solid electrolyte.
4. A method of producing a positive electrode active material includes the following (a) to (c).
(a) A coating liquid is prepared.
(b) A mixture is prepared by mixing the coating liquid and an active material particle.
(c) A positive electrode active material is produced by drying the mixture.

The coating liquid includes a glass forming material. The glass forming material includes a condensed phosphate compound and silicon. The condensed phosphate compound includes diphosphorus pentaoxide at a mass fraction of 83% or more.

The mass fraction (hereinafter, also referred to as “P₂O₅ concentration”) of the diphosphorus pentaoxide (P₂O₅) in the condensed phosphate compound is an indicator for a degree of polymerization. It is considered that as the P₂O₅ concentration is higher, the condensed phosphate compound has a higher degree of polymerization. When the P₂O₅ concentration is 83% or more, a reduction in battery resistance is expected. This is presumably because continuity of the glass network can be improved in the coating film.
5. The method of producing a positive electrode active material according to “4” above may include, for example, the following configuration. The (a) includes the following (a1) and (a2).
(a1) The condensed phosphate compound is synthesized by a dehydration condensation reaction of a phosphate compound.
(a2) Silicon is added to a reaction system of the dehydration condensation reaction.

By adding Si to the reaction system of the dehydration condensation reaction, Si can be introduced into the phosphate network (condensed phosphate compound). Since Si is incorporated in the phosphate network in advance, an improvement in ion conductivity is expected.

The following describes an embodiment of the present disclosure (hereinafter, also simply referred to as “the present embodiment”) and an example of the present disclosure (hereinafter, also simply referred to as “the present example”). However, the present embodiment and the present example do not limit the technical scope of the present disclosure. The present embodiment and the present example are illustrative in all respects. The present embodiment and the present example are non-restrictive. The technical scope of the present disclosure includes all the modifications within the scope and meaning equivalent to the description of claims. For example, it is initially expected to freely extract configurations from the present embodiment and the present example and freely combine them.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual diagram of a positive electrode active material in the present embodiment.

FIG. 2 is a schematic flowchart of a method of producing a positive electrode active material according to the present embodiment.

FIG. 3 is a conceptual diagram of an all-solid-state battery according to the present embodiment.

FIG. 4 is a table showing experimental results.

FIG. 5 is a graph showing the relationship between the Si composition ratio and the battery resistance.

FIG. 6 is a graph showing the relationship between P₂O₅ concentration and battery resistance.

### DESCRIPTION OF THE EMBODIMENTS

### Description of Terms

The “element concentration (C_{Li}, C_{X}, C_{Si})” indicates a value measured by the following procedure. For example, an XPS apparatus (product name “PHI X-tool”) manufactured by Ulvac Phi or equivalents thereof is prepared. The positive electrode active material (powder) is set in an XPS device. A narrow scan analysis is performed with a pass energy of 224 eV. The measurement data is processed by the analysis software. For example, analysis software fair (product name “MulTiPak”) manufactured by Ulvac Phi or equivalents thereof may be used. The peak area (integral value) of the Li1s spectrum is converted to the element concentration (C_{Li}) of Li. The peak area of the P2p spectrum is converted to the element concentration (C_{P}) of P. The peak area of the B1s spectrum is converted to the element concentration (C_{B}) of B. The peak area of the Si2p spectrum is converted to the element concentration (C_{Si}) of Si. C_{X} is the total element concentration of the glass forming elements. For example, when three kinds of glass forming elements of P, B, and Si are detected, C_{X} is obtained by the formula “C_{X}=C_{P}+C_{B}+C_{Si}”.

The “glass forming element” may combine with O to form an oxide glass having a network structure. The glass forming element may include, for example, P, Si, B, nitrogen (N), sulfur(S), germanium (Ge), hydrogen (H), and the like. “Glass forming material” refers to a material containing a glass forming element. The glass forming material may be either a simple substance, a compound, or a mixture.

The “P₂O₅ concentration” indicates a value measured in the following procedure. 0.1 mL of sample (condensed phosphate compound) and 0.9 mL of distilled water are placed in a plastic cuvette. Absorbance at a wavelength of 360 nm is measured. The P₂O₅ concentration of the sample is obtained from the relationship between the absorbance and the P₂O₅ concentration (calibration curve).

A numerical range such as “m to n %” includes an upper limit value and a lower limit value unless otherwise specified. That is, “m to n %” indicates a numerical range of “m % or more and n % or less”. Further, “m % or more and n % or less” includes “more than m % and less than n %”.

The execution order of a plurality of steps, operations, and the like included in various methods is not limited to the described order unless otherwise specified. For example, multiple steps may proceed simultaneously. For example, a plurality of steps may be performed before and after each other.

### <Positive Electrode Active Materials>

The positive electrode active material may comprise one particle. The positive electrode active material may include two or more particles. That is, the positive electrode active material may be powder (aggregation of particles). The positive electrode active material may have a D50 of, for example, 1 to 30 μm, 10 to 20 μm, or 1 to 10 μm. “D50” represents the particle diameter at which the integration becomes 50% in the particle size distribution (integral distribution) based on the volume. The particle size distribution can be measured by laser diffraction.

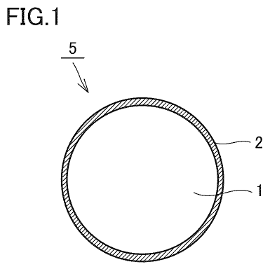

FIG. 1 is a conceptual diagram of a positive electrode active material in the present embodiment. The positive electrode active material 5 includes composite particles. The composite particles have a core-shell structure. That is, the positive electrode active material 5 includes the active material particles 1 and the coating film 2. The positive electrode active material 5 can be called, for example, a “covered active material”.

### <Coating Film>

The coating film 2 is a shell of the positive electrode active material 5. The coating film 2 covers at least a part of the surface of the active material particles 1. The coverage ratio may be, for example, 94% or more. The coverage ratio may be, for example, 95% or more, 96% or more, or 97% or more. The coverage ratio may be, for example, 100% or less, 97% or less, 96% or less, or 95% or less.

“Coverage ratio” is measured by XPS. The element concentrations of various elements on the surface of the positive electrode active material are measured by XPS. The coverage ratio is obtained by the following formula (4).

$$θ = {C}_{X} / ( {C}_{X} + {C}_{Y} ) \qquad ( 4 )$$

In the above formula (4), 0 represents a coverage ratio. Coverage ratio is expressed in percentage (%). C_{X} represents the total element concentration of the glass forming elements. For example, when the coating film 2 contains P, B, and Si, C_{X} is obtained by the formula “C_{X}=C_{P}+C_{B}+C_{Si}”. C_{Y} represents the total element concentration of the constituent elements (However, Li and O are excluded.) of the active material particles 1. For example, when the active material particles 1 have a composition of “LiNi_{1/3}Co_{1/3}Mn_{1/3}O₂”, C_{Y} is obtained by the formula “C_{Y}=C_{Co}+C_{Ni}+C_{Mn}”. For example, when the active material particles have a composition of “LiNi_{0.8}Co_{0.15}Al_{0.05}O₂”, C_{Y} is obtained by the formula

$${″}^{} {C}_{Y} = {C}_{Co} + {C}_{Ni} + {{C}_{Al}}^{″} .$$

The thickness of the coating film 2 may be, for example, 5 to 100 nm, 5 to 50 nm, 10 to 30 nm, or 20 to 30 nm. The thickness of the coating film 2 can be measured, for example, by cross-sectional observation of composite particles. Cross-sectional observation can be performed, for example, by SEM (Scanning Electron Microscope).

The coating film 2 contains O and a glass forming element (X). The glass forming elements include P and Si. The glass forming element may further contain at least one element selected from the group consisting of B, N, S, Ge and H, for example, in addition to P and Si. The glass forming elements may include, for example, P, Si and B. The coating film 2 may include, for example, a phosphate skeleton, a silicate skeleton, a borate skeleton, or the like. For example, TOF-SIMS (Time-of-Flight Secondary Ion Mass Spectrometry) spectrum of the positive electrode active material 5 may include fragment peaks derived from PO₂⁻, PO₃⁻, SiO₃⁻, SiO₄⁻, Si₂O₅⁻, BO₂⁻, BO₃⁻, etc.

The coating film 2 may contain Li. In the present embodiment, the relationship of the following formula (1) is satisfied.

$${C}_{Li} / {C}_{X} \leq 2.5 \qquad ( 1 )$$

When the relationship of the above formula (1) is satisfied, a reduction in battery resistance is expected. Two or more Li sources in the coating film 2 are conceivable. For example, the coating film 2 may contain Li derived from a Li compound contained in the coating liquid. For example, the coating film 2 may contain Li diffused from the active material particles 1 when the coating film 2 is formed.

The Li composition ratio (C_{Li}/C_{X}) may be, for example, 2.46 or less, 2.45 or less, 2.42 or less, 2.37 or less, or 1.40 or less. The Li composition ratio may be, for example, 0.1 or more, 0.5 or more, 1.0 or more, 1.40 or more, or 2.00 or more.

The Si composition ratio is optional as long as the relationship of the following formula (2) is satisfied.

$$0 < {C}_{Si} / {C}_{X} \qquad ( 2 )$$

For example, the relationship of the following formula (3) may be satisfied.

$${C}_{Si} / {C}_{X} < 0.1 \qquad ( 3 )$$

The Si composition ratio (C_{Si}/C_{X}) may be, for example, 0.01 or more, 0.02 or more, 0.03 or more, 0.04 or more, 0.05 or more, or 0.06 or more. The Si composition ratio may be, for example, 0.09 or less, 0.08 or less, 0.07 or less, or 0.06 or less.

When the coating film 2 contains B, the quantitative relationship between P and B is optional. For example, the relationship of “C_{P}/C_{B}=99/1 to 1/99”, “C_{P}/C_{B}=9/1 to 1/9” or “C_{P}/C_{B}=7/3 to 3/7” may be satisfied. For example, a relationship such as “1≤C_{P}/C_{B}” or “2≤C_{P}/C_{B}” may be satisfied.

### <Active Material Particles>

The active material particles 1 are cores of the positive electrode active material 5. The active material particles 1 may have a D50 of, for example, 1 to 30 μm, 10 to 20 μm, or 1 to 10 μm. The active material particles 1 can reversibly store Li ions. The active material particles 1 may have any crystal structure. The active material particles 1 may include, for example, a lamellar rock salt structure.

The active material particles 1 may have any composition. The active material particles 1 may have, for example, a composition represented by the following formula (5).

Li₁₋ₐNiₓM₁₋ₓO₂ (5)

In the above formula (5), the relationship of −0.5≤a≤0.5 and 0<x<1 is satisfied. M is at least one kind selected from the group consisting of Co, Mn and Al. For example, the relationship 0.5≤x<1 or 0.6≤x≤0.9 may be satisfied.

A dopant may be added to the active material particles 1. The dopant may diffuse throughout the particle or may be locally distributed. For example, the dopant may be unevenly distributed on the particle surface. The dopant may be a substitutional solid solution atom or an interstitial solid solution atom. The amount of dopant added (molar fraction with respect to the whole active material particles 1) may be, for example, 0.01 to 5%, 0.1 to 3%, or 0.1 to 1%. The dopant may include, for example, at least one selected from the group consisting of B, C, N, halogen, Si, Na, Mg, Al, Mn, Co, Cr, Sc, Ti, V, Cu, Zn, Ga, Ge, Se, Sr, Y, Zr, Nb, Mo, In, Pb, Bi, Sb, Sn, W, La, Ce, Pr, Nd, Pm, Sm, Eu, Gd, Tb, Dy, Ho, Er, Tm, Yb, Lu, and actinoids.

### <Method of Producing a Positive Electrode Active Material>

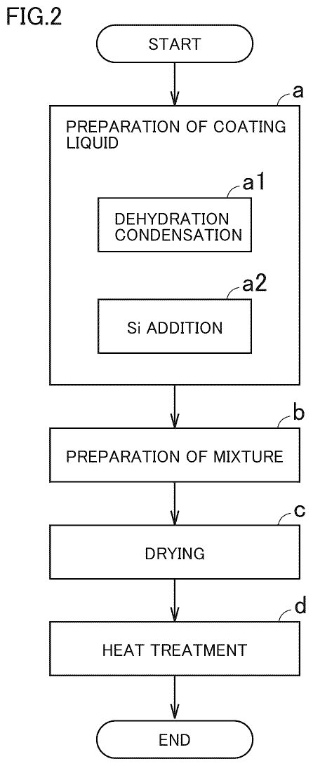

FIG. 2 is a schematic flowchart of a method of producing a positive electrode active material according to the present embodiment. Hereinafter, the “method of producing a positive electrode active material in the present embodiment” may be abbreviated as “the production method”. The production method includes “(a) preparation of a coating liquid”, “(b) preparation of a mixture”, and “(c) drying”. The production method may further include, for example, “(d) heat treatment” or the like.

### <(a) Preparation of Coating Liquid>

The production method includes providing a coating liquid. The coating liquid includes a solute and a solvent. For example, a coating liquid may be formed by dissolving various materials in a solvent. The solvent may include any component so long as the solute can dissolve. The solvent may include, for example, water, alcohol, etc. The solvent may include, for example, ion-exchanged water, methanol, ethanol, etc.

The blending amount of the solute may be, for example, 0.1 to 20 parts by mass with respect to 100 parts by mass of the solvent. The solute includes a glass forming material. That is, the coating liquid includes a glass forming material. The glass forming material includes a condensed phosphate compound and Si. The glass forming material may further comprise a borate compound or the like. The solute may further contain, for example, a Li compound. For example, a coating liquid may be prepared by dissolving a condensed phosphate compound, a Si compound, a Li compound, a borate compound, and the like in a solvent.

The condensed phosphate compound is a source of P. The condensed phosphate compound may contain, for example, at least one selected from the group consisting of pyrophosphate, polyphosphate, metaphosphate, and phosphoric anhydride. The condensed phosphate compound may be a hydrate, a salt, or the like. The condensed phosphate compound has a P₂O₅ concentration of 83% or more. The P₂O₅ concentration may be, for example, 84% or more, 85% or more, 86% or more, 87% or more, 88% or more, or 89% or more. The P₂O₅ concentration may be, for example, 100% or less, 95% or less, 89% or less, or 84% or less.

<(a1) Dehydration Condensation>

The production method may include synthesizing a condensed phosphate compound by a dehydration condensation reaction of the phosphate compound. The phosphate compound (starting material) may contain, for example, orthophosphate or the like. The phosphate compound may be a hydrate, a salt, or the like. The concentration of P₂O₅ in the condensed phosphate compound can be adjusted by dehydration condensation conditions. For example, the dehydration condensation reaction may proceed by heating the phosphate compound. The heating temperature may be, for example, 400 to 500° C. The heating time may be, for example, 2 to 6 hours, 2 to 4 hours, or 4 to 6 hours.

<(a2) Si Addition>

The production method may include adding Si to the reaction system of the dehydration condensation reaction. When Si is added during the progress of the dehydration condensation reaction of the phosphate compound, Si can be introduced into the condensed phosphate compound. By incorporating Si in the phosphate network in advance, an improvement in ion conductivity is expected.

The addition method is optional. For example, a crucible containing Si may be prepared. For example, a porcelain crucible may contain Si. The crucible is filled with a phosphate compound. Heating the crucible may cause a dehydration condensation reaction of the phosphate compound. At the same time, Si can be added to the reaction system by eluting Si from the crucible. The amount of Si added can be adjusted by, for example, the content of Si in the crucible, the heating temperature, and the heating time.

For example, a Si compound (e.g., SiO₂) may be added to the phosphate compound during heating. The Si compound may be powder, for example. For example, a mixture of a phosphate compound and a Si compound may be heated.

The amount of Si added can be expressed by the Si concentration in the condensed phosphate compound. The Si concentration (mass fraction) may be, for example, 600 ppm or more, 708 ppm or more, 1251 ppm or more, 1488 ppm or more, or 2353 ppm or more. The Si concentration may be, for example, 2353 ppm or less, 1488 ppm or less, 1251 ppm or less, or 708 ppm or less. The Si concentration can be measured by ICP emission spectroscopy (Inductively Coupled Plasma Atomic Emission Spectroscopy, ICP-AES).

### <Li Compound>

The Li compound is a Li source. The solute may contain a Li compound as long as the Li composition ratio of the positive electrode active material 5 can be 2.5 or less. The Li compound may contain, for example, lithium hydroxide, lithium nitrate, lithium carbonate, and the like. The timing of addition of the Li compound is optional. For example, similar to Si, the Li compound may be added to the reaction system of the dehydration condensation reaction of the phosphate compound.

The amount of Li added can be expressed by the Li concentration in the condensed phosphate compound. The Li concentration (mass fraction) may be, for example, 1.4% or more, 1.48% or more, 1.6% or more, 1.65% or more, or 1.7% or more. The Li concentration may be, for example, 1.7% or less, 1.65% or less, 1.6% or less, 1.48% or less, or 1.4% or less.

### <Borate Compound>

Borate compounds are B sources. The borate compound may contain, for example, orthoborate, metaborate, tetraborate, or the like. The borate compound may be a hydrate, a salt, or the like. The addition timing of the borate compound is optional. For example, after the condensed phosphate compound is dissolved in the solvent, the borate compound may be further dissolved.

### <(b) Preparation of Mixture>

The production method includes mixing a coating liquid and active material particles 1 to prepare a mixture. The mixture may be either a suspension or a wet powder, for example. For example, a suspension may be formed by dispersing the active material particles 1 (powder) in the coating liquid. For example, a wet powder may be formed by spraying a coating liquid into the powder. In the production method, any mixing device, granulation device, or the like may be used.

### <(c) Drying>

The production method includes producing the positive electrode active material 5 by drying the mixture. The coating liquid adhered to the surface of the active material particles 1 is dried to form the coating film 2. In the production method, any drying method may be used. For example, the mixture may be dried by a spray dryer. That is, droplets are formed by spraying the suspension from the nozzle. The droplet contains active material particles 1 and a coating liquid. For example, the positive electrode active material 5 may be formed by drying droplets by hot air. The use of the spray dry method is expected to improve the coverage ratio, for example.

For example, the positive electrode active material 5 may be produced by a rolling fluidized bed coating apparatus. In the rolling fluidized bed coating apparatus, “(b) preparation of mixture” and “(c) drying” may proceed substantially simultaneously.

### <(d) Heat Treatment>

The production method may include subjecting the positive electrode active material 5 to a heat treatment. The coating film 2 can be fixed by heat treatment.

The heat treatment may also be referred to as “calcination”. In the production method, any heat treatment apparatus may be used. The processing temperature may be, for example, 150 to 300° C. The treatment time may be, for example, 1 to 10 hours. The heat treatment atmosphere may be, for example, an air atmosphere or an inert atmosphere.

### <All-Solid-State Battery>

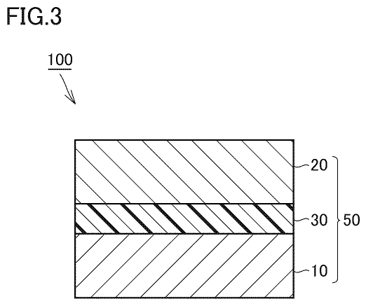

FIG. 3 is a conceptual diagram of an all-solid-state battery according to the present embodiment. Battery 100 may have any profile. The battery 100 may have, for example, a plate-like outer shape. The battery 100 includes a power generation element 50. The battery 100 may include an exterior package (not shown). The exterior package may house the power generation element 50. The exterior package may be, for example, an Al laminate film pouch or the like. The power generation element 50 includes a positive electrode 10 and a negative electrode 20. The power generation element 50 may further comprise a separator layer 30. The separator layer 30 is disposed between the positive electrode 10 and the negative electrode 20. The power generation element 50 may have any structure. The power generation element 50 may have either a monopolar structure or a bipolar structure, for example.

The positive electrode 10 may include, for example, a positive electrode current collector and a positive electrode active material layer. The positive electrode current collector may include, for example, an Al foil or the like. The positive electrode active material layer may be disposed on the surface of the positive electrode current collector. The positive electrode active material layer includes a positive electrode active material and a sulfide solid electrolyte.

The blending amount of the sulfide solid electrolyte may be, for example, 1 to 200 parts by volume based on 100 parts by volume of the positive electrode active material. The sulfide solid electrolyte may be, for example, either glass ceramics or argyrodite. The sulfide solid electrolyte may include, for example, at least one selected from the group consisting of LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—GeS₂—P₂S₅, Li₂S—P₂S₅, Li₁₀GeP₂S₁₂, Li₄P₂S₆, Li₂P₃S₁₁, Li₃PS₄, Li₂PS₆, and Li₆PS₅X (X=Cl, Br, I).

For example, “LiI—LiBr—Li₃PS₄” represents a sulfide solid electrolyte produced by mixing LiI, LiBr and Li₃PS₄ at any molar ratio. For example, a sulfide solid electrolyte may be produced by a mechanochemical method. The mixing ratio may be identified by numbering before each feedstock. For example, “10LiI-15LiBr-75Li₃PS₄” indicates that the mixture ratio of raw materials is “LiI/LiBr/Li₃PS₄=10/15/75 (molar ratio)”.

The positive electrode active material layer may further include, for example, a conductive material, a binder, and the like. The blending amount of the conductive material and the binder may be, for example, 0.1 to 10 parts by mass with respect to 100 parts by mass of the positive electrode active material. The conductive material may include, for example, acetylene black, vapor-grown carbon fiber (VGCF), etc. The binder may include, for example, polyvinylidene difluoride (PVDF), styrene-butadiene rubber (SBR), or the like.

### Examples

### <Samples>

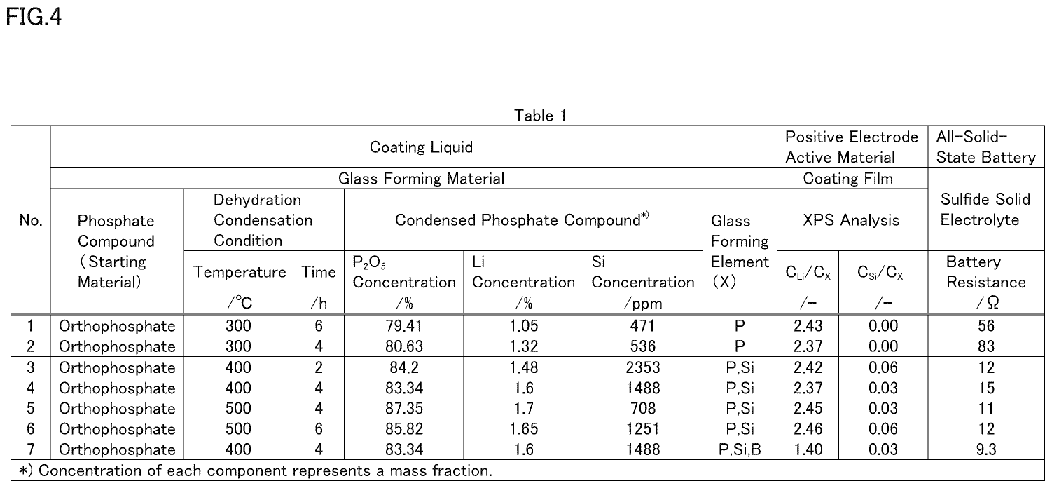

FIG. 4 is a table showing experimental results. A positive electrode active material and an all-solid-state battery according to Nos. 1 to 7 were produced as follows.

### No. 1

10.8 parts by mass of the condensed phosphate compound (manufactured by Rasa Industries) was dissolved in 166 parts by mass of ion-exchanged water to prepare a coating liquid.

The procedure for producing the condensed phosphate compound was as follows. A mixture was prepared by mixing orthophosphate and lithium hydroxide monohydrate. The mass fraction of lithium hydroxide monohydrate in the mixture was 6%. The mixture was placed in a porcelain crucible. The crucible was stored in an electric furnace for 6 hours. The set temperature of the electric furnace was 300° C. The dehydration condensation reaction of orthophosphate produced a condensed phosphate compound. The “temperature” in the dehydration condensation condition of FIG. 4 indicates the set temperature (heating temperature) of the electric furnace, and the “time” indicates the holding time (heating time).

A suspension was prepared by dispersing 50 parts by mass of active material particles (LiNi_{1/3}Co_{1/3}Mn_{1/3}O₂) in 53.7 parts by mass of a coating liquid. A positive electrode active material was produced by supplying the suspension to a spray dryer (Product name “Mini Spray Dryer B-290”, manufactured by BUCHI.). The air supply temperature of the spray dryer was 200° C., and the air supply air volume was 0.45 m³/min. The positive electrode active material was heat treated in air. The heat treatment temperature was 200° C.

A positive electrode slurry was prepared by mixing a positive electrode active material, a sulfide solid electrolyte (10LiI-15LiBr-75Li₃PS₄), a conductive material (VGCF), a binder (SBR), and a dispersion medium (heptane). The mixture ratio of the positive electrode active material and the sulfide solid electrolyte was “positive electrode active material/sulfide solid electrolyte=6/4 (volume ratio)”. The blending amount of the conductive material and the binder was 3 parts by mass with respect to 100 parts by mass of the positive electrode active material. The positive electrode slurry was sufficiently stirred by the ultrasonic homogenizer. The positive electrode slurry was coated on the surface of the positive electrode current collector (Al foil) to form a coating film. The coating was dried on a hot plate at 100° C. for 30 minutes. Thus, a positive electrode raw sheet was produced. A disc-shaped positive electrode was cut out from the positive electrode raw sheet. The area of the positive electrode was 1 cm².

A negative electrode and a separator layer were prepared. The negative electrode active material was graphite. The same type of sulfide solid electrolyte was used between the positive electrode, the separator layer, and the negative electrode. In the cylindrical jig, the positive electrode, the separator layer, and the negative electrode were stacked in this order to form a stack. The stack was pressed to form a power generation element. An all-solid-state battery was formed by connecting terminals to the power generation element.

### No. 2 to No. 6

As shown in FIG. 4, a positive electrode active material and an all-solid-state battery were produced in the same manner as in No. 1 except that the dehydration condensation conditions were changed.

### No. 7

10.8 parts by mass of the condensed phosphate compound was dissolved in 166 parts by mass of ion-exchanged water to prepare a phosphate solution. Further, borate (manufactured by NACALAI TESQUE) was dissolved in the phosphate solution so that “C_{P}/C_{B}=1” was obtained, whereby a coating liquid was prepared. Except for these, a positive electrode active material and an all-solid-state battery were produced in the same manner as in No. 4.

### <Evaluation>

In the condensed phosphate compound, the P₂O₅ concentration, the Li concentration and the Si concentration were measured. The Li composition ratio, Si composition ratio, and coverage ratio of the positive electrode active material were measured by an XPS apparatus. The resistance of the all-solid-state battery (battery resistance) was measured. The measurement results are shown in FIG. 4.

### <Results>

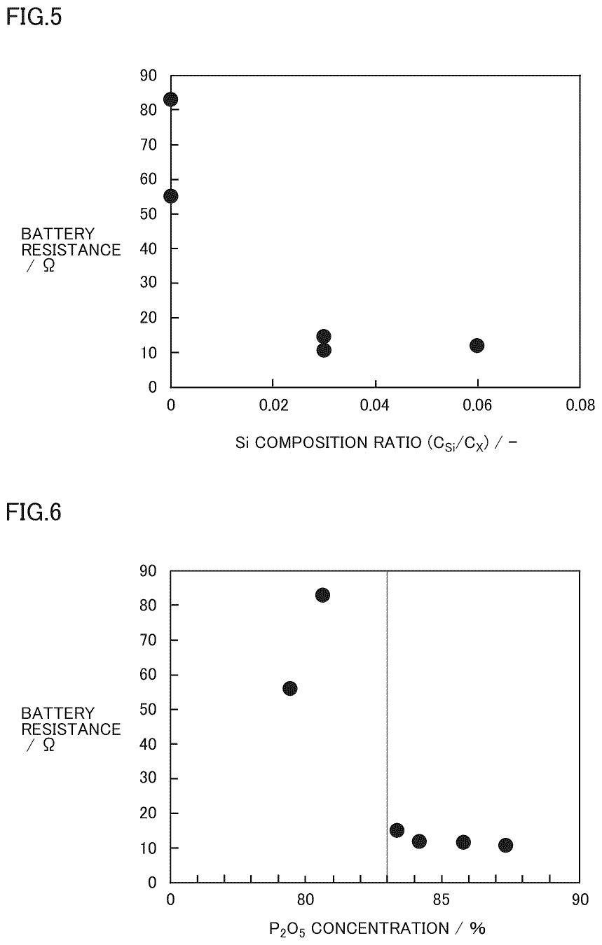

FIG. 5 is a graph showing the relationship between the Si composition ratio and the battery resistance. FIG. 5 plots the results of No. 1 to No. 6. When the Si composition ratio (C_{Si}/C_{X}) is greater than 0, the battery resistance tends to be significantly reduced.

FIG. 6 is a graph showing the relationship between P₂O₅ concentration and battery resistance. FIG. 6 plots the results of No. 1 to No. 6. When the P₂O₅ concentration is 83% or more, the battery resistance tends to be significantly reduced.

What is claimed is:

1. A positive electrode active material comprising:
an active material particle; and
a coating film, wherein
the coating film covers at least a part of a surface of the active material particle,
the coating film includes oxygen and a glass forming element,
the glass forming element includes phosphorus and silicon, and
relationships of the following formulas (1) and (2) are satisfied:
$${C}_{Li} / {C}_{X} \leq 2.5 ; and \qquad ( 1 )$$
$$0 < {C}_{Si} / {C}_{X} , \qquad ( 2 )$$
where
C_{Li}, C_{X} and C_{Si} respectively represent element concentrations measured by X-ray photoelectron spectroscopy, C_{Li} represents an element concentration of lithium, and C_{X} represents a total element concentration of the glass forming element, and C_{Si} represents an element concentration of silicon.

2. The positive electrode active material according to claim 1, wherein
the glass forming element further includes boron, and
a relationship of the following formula (3) is further satisfied:
$${C}_{Si} / {C}_{X} < 0.1 . \qquad ( 3 )$$

3. An all-solid-state battery comprising:
a positive electrode; and
a negative electrode, wherein
the positive electrode includes the positive electrode active material according to claim 1 and a sulfide solid electrolyte.

4. A method of producing a positive electrode active material, the method comprising:
(a) preparing a coating liquid;
(b) preparing a mixture by mixing the coating liquid and an active material particle; and
(c) producing a positive electrode active material by drying the mixture, wherein
the coating liquid includes a glass forming material,
the glass forming material includes a condensed phosphate compound and silicon, and
the condensed phosphate compound includes diphosphorus pentaoxide at a mass fraction of 83% or more.

5. The method of producing a positive electrode active material according to claim 4, wherein
the (a) includes
(a1) synthesizing the condensed phosphate compound by a dehydration condensation reaction of a phosphate compound, and
(a2) adding silicon to a reaction system of the dehydration condensation reaction.
